(19) United States
(12) Patent Application Publication
(10) Pub. No.: US 2017/0055665 A1
(43) Pub. Date: Mar. 2, 2017

(54) Compartmentalized carryall

(71) Applicant: Lisa Lanzisera, Tampa, FL (US)

(72) Inventor: Lisa Lanzisera, Tampa, FL (US)

(21) Appl. No.: 14/833,761

(22) Filed: Aug. 24, 2015

(51) Int. Cl. A45C 15/00; B67D 3/00; A45C 13/10; A45C 3/06; A45C 13/02

(52) U.S. Cl. CPC A45C 15/00; A45C 3/06; A45C 13/02; A45C 13/103; B67D 3/0029; B67D 3/0061; A45C 2200/20

(57) ABSTRACT

A compartmentalized carryall with a compartment for items, including electronic personal items, and a separately attached insulated compartment for a container that can be accessed for dispensing via an opening with a cover. This carryall would be comprised of at least two compartments. One compartment could be utilized for carrying items including wallets and electronics, such as key fobs and cellular phones. Another insulated compartment would carry a container. This container, with an attached dispensing mechanism, would be accessed through an opening from the carryall's second compartment to the carryall's exterior. This opening would be overlaid with a removable cover attached on the carryall's exterior. At least one handle strap would be attached to carryall.

### CROSS-REFERENCE TO RELATED APPLICATIONS

I hereby claim benefit under Title 35, United States Code, Section 120 of U.S. patent application No. 62/045,961 filed Sep. 4, 2014. This provisional patent as Prior Application is hereby incorporated into this application.

### TECHNICAL FIELD

The present invention relates, in general, to carryalls, and, more particularly, compartmentalized carryalls that are used to transport and store everyday electronic devices with direct beverage dispensing containers.

### BACKGROUND ART

Any discussion of the prior art throughout the specification should in no way be considered as an admission that such prior art is widely known or forms part of general knowledge in the field.

Traditionally, carryalls are made to carry everyday items such as wallets, electronic key fobs, and cellular phones. These carryalls are not designed to transport, let alone dispense, beverages directly from an insulated compartment within the carryall.

Carrying beverages along with electronic devices in the same compartment or in an adjoining, un-insulated portion of a carryall can easily cause damage to electronic items by exposing them to moisture and fluid exposure. Carrying everyday items such as pens could also puncture a beverage-containing bag if both are being stored and transported in the same compartment.

The space allowed for carrying everyday items must be adequate enough to store larger cellular phones, electronic tablets, and fobs with multiple keys in addition to other items such as wallets. An area that could be possibly described as a credit card-sized pouch is not sufficient for daily use.

Conversely, there are handbags on the market that are designed to only carry beverages that can only be dispensed from plastic bags with pre-attached spigots. These handbags do not have the capability to separate moisture-sensitive items from the beverage bags in two separate contained compartments. These handbags are not designed to accommodate longer-sized items such as a wine bottle fitted with a stopper/pourer and positioned to allow dispensing of the wine directly from the bag.

In addition, these handbags are designed to have a spigot protruding from the handbag allowing an open display of the spigot in an unhygienic environment. As handbags are routinely laid on public counters, floors, and tables, the element of unhealthy contamination is evident.

Discreet transportation of a beverage for dispensing cannot be accomplished with a protruding spigot.

Most of these handbags described also do not have insulation material surrounding the beverage for optimal serving temperature.

While some coolers do have potential areas for carrying everyday items, the dispensing of beverages directly into a receptacle is not possible. These coolers will overtly display the cooler's contents when retrieving a beverage from the cooler's compartment.

For a carryall to be portable, it should have a strap or handle providing ease of conveyance. A carryall is meant to be transported and is not designed to simply sit on a counter. It should also have a decorative aspect as it is considered an accessory for those who are carrying it. A simple box with an exposed spigot does not lend itself to either of the above carryall requirements.

### SUMMARY OF THE EMBODIMENTS

In general, a first embodiment includes a carryall with two handle straps and two separate compartments. An aspect of the lower compartment having a thermally isolating and water-resistant interior shell with an opening on one gusset side designed to accept a dispensing mechanism in the form of a spigot, tap, flask lid, pourer/stopper or similar mechanism through to the exterior of the carryall. This opening is overlaid with a cover flap until in use. An aspect of the upper compartment designed to safely carry everyday items, including electronic devices, in an area that would not be overtly exposed to liquid beverages or moisture from containers containing liquids.

In another aspect of the present invention, an inclined floor of the beverage compartment allows for easier dispensing of a beverage through gravitational force.

In another aspect of the present invention, a foam liner or other insulating material assists with temperature maintenance of the beverage compartment.

In another aspect of the present invention, an area in the item compartment is separated for the purpose of a hygienic environment for drinking implements or other items within the lining of this upper compartment.

In another aspect of the present invention, a second beverage compartment with concealed opening is added allowing for more than one type of beverage to be directly dispensed from the carryall.

In another aspect of the present invention, a cover flap is completely removable from the area of the opening on the gusset of the beverage compartment and may be attached by a chain or similar device extending from the cover flap to the compartmentalized carryall.

In another aspect of the present invention, the cover flap is enlarged to adequately cover the dispensing mechanism while the dispensing mechanism is fully exposed and positioned outside the beverage compartment.

In another aspect of the present invention, the opening is expanded or contracted to allow for variable sized dispensing mechanisms and to prevent unintended withdrawal of the dispensing mechanism back into the beverage compartment.

This novel compartmentalized carryall can be shaped like a shoulder bag, purse, handbag, backpack, briefcase, fanny pack, or any other form. The carryall can be held over the shoulder, across the body, alongside the body, around the body, or on the back.

### BRIEF DESCRIPTION OF THE DRAWINGS

Further features and advantages of the present invention will become apparent from the following detailed description, taken in combination with the appended drawings, in which;

FIG. 1 is a perspective view of a carryall in accordance with an embodiment of the present invention;

FIG. 2 is a perspective view of the carryall of FIG. 1, depicted with the cover flap in the open position, revealing the beverage compartment opening;

FIG. 3 is a perspective view of the carryall of FIG. 1, revealing the partial continuity of one panel between the beverage compartment and the item compartment and an operable fastening device connecting the compartments along their horizontal borders;

FIG. 4 is a perspective view of the carryall of FIG. 1, depicted with the entire beverage compartment open, revealing the interior of the beverage compartment;

FIG. 5 is a cross-sectional view of the carryall of FIG. 1, depicting the interior space of the item compartment and the beverage compartment;

FIG. 6 is a cross-sectional view of a carryall in accordance with another embodiment of the present invention in which a third compartment has been added, a cover flap has been enlarged, the area between the lining and the base of the item compartment has been made accessible for storage, and the bottom panels of the beverage compartment have been inclined;

FIG. 7 is a perspective view of a carryall with another embodiment of the present invention in which the carryall is in the shape of a backpack, with substantial insulation of the beverage compartment and a wide opening in the beverage compartment.

It should be noted that throughout the appended drawings, like features are identified by like reference numerals. The drawings are not necessarily drawn to scale.

### DETAILED DESCRIPTION

In general, and as will be elaborated below, the present invention provides an innovative carryall with a discreet beverage dispensing capability.

Embodiments of this invention will now be described in greater detail below, with reference to the accompanying figures.

### Overview

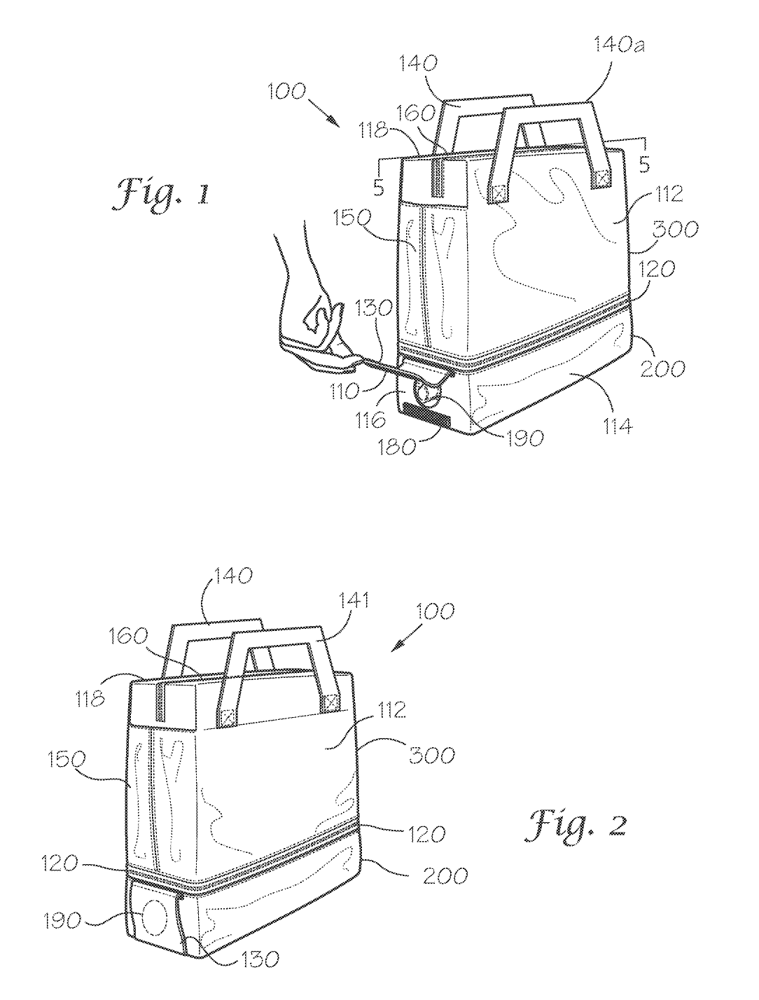

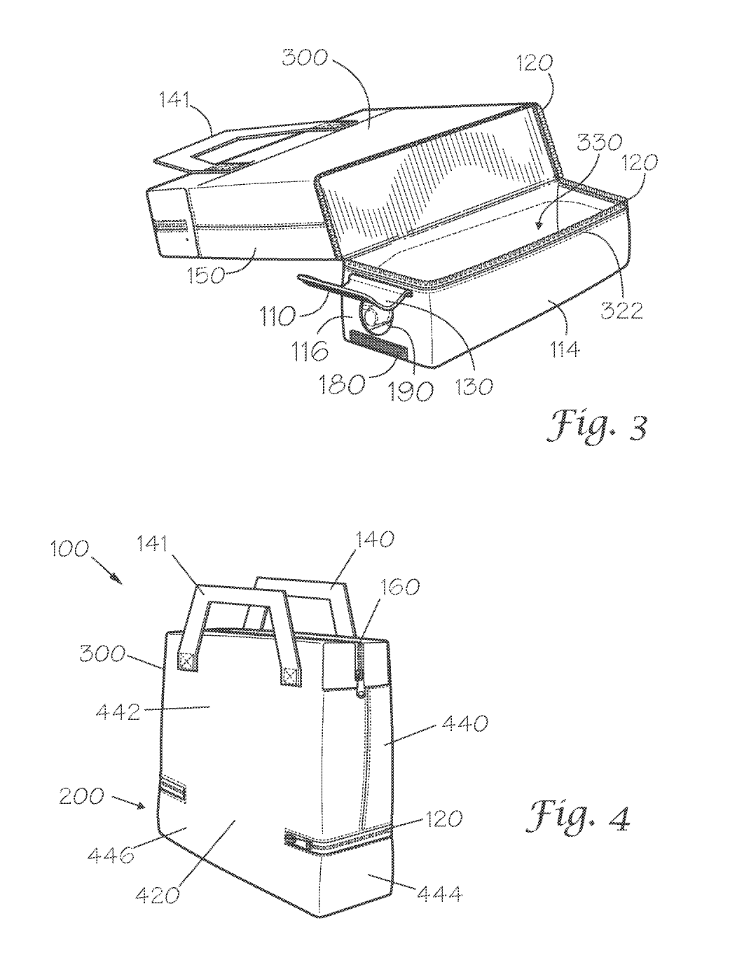

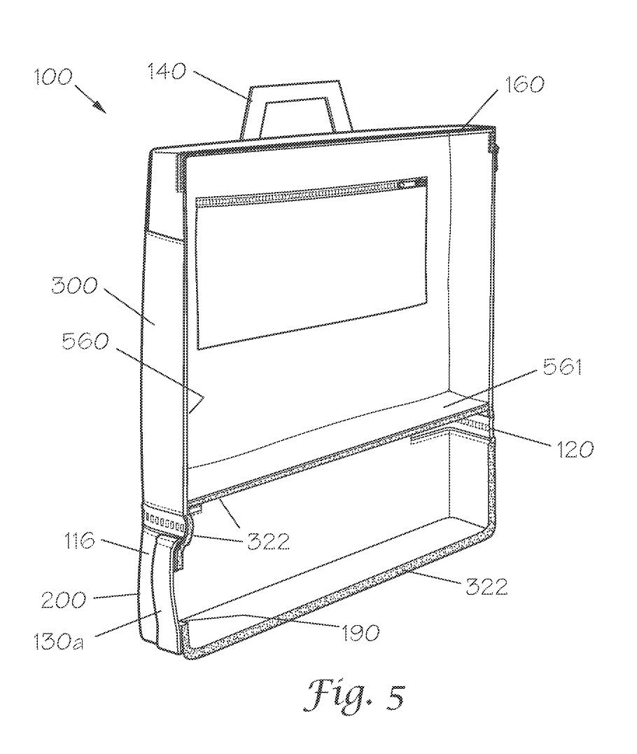

By way of overview, FIGS. 1 to 5 depict a first embodiment of the present invention, namely a carryall with two distinct but attached compartments, one for carrying everyday items including electronic items such as cell phones in a readily accessible compartment while also carrying beverages that can be easily and discreetly dispensed from a separate container that has been placed in the second, insulated compartment.

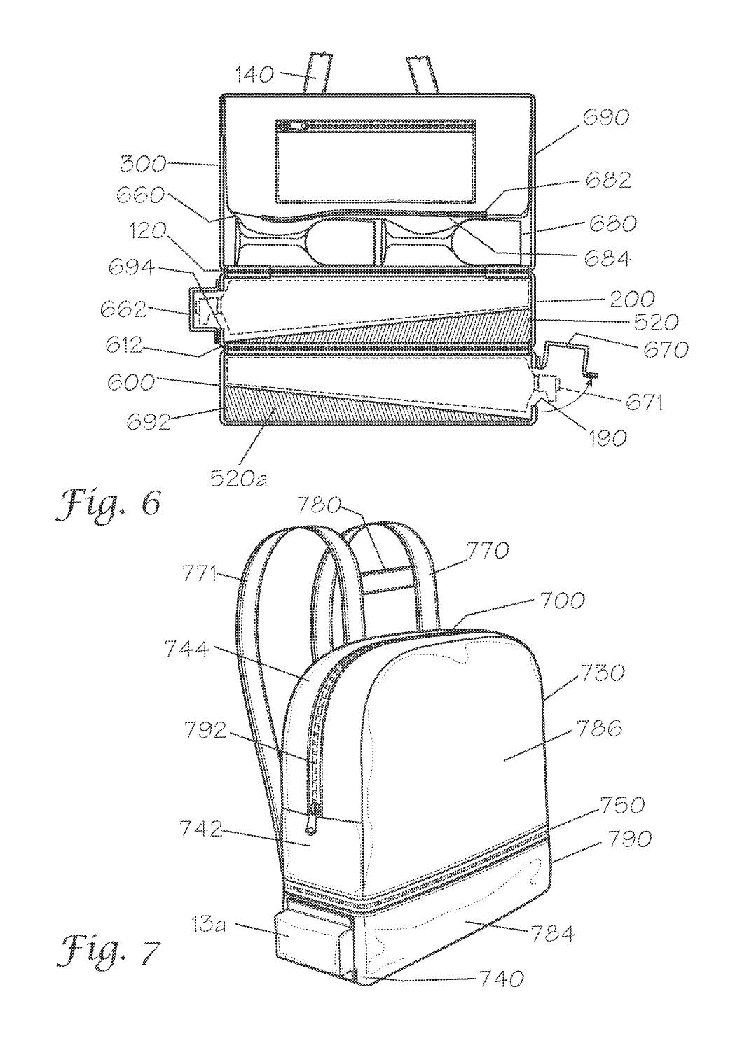

FIG. 6 depicts a second embodiment of the present invention, namely a three-compartment carryall that has other useful features beyond the ability to carry an additional beverage container, including a slanted beverage compartment floor, a wider cover flap, a completely removable cover flap that may be attached with a small chain, and a storage area beneath the item compartment lining.

FIG. 7 depicts a third embodiment of the present invention namely a backpack-style carryall with a beverage dispensing capability directly from an insulated compartment.

These three main embodiments are presented merely to exemplify various interesting and innovative aspects of the invention, and are not intended to limit the scope of the invention. As will become apparent from this disclosure, there are many possible variations on the embodiments listed herein. For example, while this carryall is depicted as generally having a purse or backpack form which can be worn using a shoulder strap, this carryall can also be incorporated within, or designed to function as a handbag, bag, lunchbox, luggage, briefcase, attaché case, fanny pack, or any other portable carryall.

In each of the embodiments depicted, the outer shell can be any hardness, color, fabric, surface finish, hard-shell materials, soft-shell materials, etc.

### First Embodiment: Carryall

In the first embodiment depicted in FIGS. 1 to 5, a carryall, which is generally designated by reference numeral 100, has two distinct compartments that are partially permanently attached 420 and partially removably attached 120, 120′. The beverage compartment 200 is a double-shelled structure 322 comprising an interior cavity that thermally isolates the contents from the environment and from the contents in the item compartment 300.

As shown if FIGS. 1 to 2 and 4 to 5, the carryall includes a cover flap 130, 130a connected to the gusset panel 116 along its superior border and removably attached at its inferior border 110,180 with specialized textured fabric, magnetic strips, or similar removable fastening devices. This cover flap 130, 130a overlays an opening 190 to the interior of the beverage compartment 200.

As depicted in FIG. 5, the item compartment 300 is separated from the beverage compartment 200 by three different layers, including but not limited to, the item compartment lining 560, the floor of the item compartment 561, and the insulating material of the superior panel of the beverage compartment 320 adding protection for the electronic items stored in the item compartment 300 from damage caused by exposure to moisture and/or liquids carried in containers in the beverage compartment 200. Access to the interior of the item compartment 300 is through the top panel 118 and fastening mechanism 160, although the top panel 118 and the fastening mechanism 160 may be omitted altogether in a variant carryall such as a tote bag.

As further depicted, in FIGS. 1 to 3,5, the carryall includes two handles 140, 141, although any other strap, handle, grip, harness, etc. may be provided so that the carryall can be carried or worn in various manners, such as, for example, as a shoulder, cross body, or hand-carried purse, a handbag, briefcase, backpack, etc.

### Operation—FIGS. 1 to 5

The manner of using the compartmentalized carryall 100 begins with opening the beverage compartment 200 by unfastening the zipper or other fastening mechanism 120,120′ and placing a beverage container with a pre-attached dispensing device into the beverage compartment with the dispensing device placed near the opening 190 of the beverage compartment 200. The cover flap 130 is dis-attached at its inferior border 180,110 exposing the opening 190. The dispensing mechanism that has been pre-attached to a beverage container is pushed through from the interior of the beverage bag 200 to the exterior.

A drinking receptacle, which may be stored in the item compartment 300, is placed under the dispensing mechanism for collecting the beverage directly from the dispensing mechanism and the beverage container.

Both a beverage container and a dispensing mechanism, which are widely available in a variety of materials and configurations, are extraneous components in this present invention and are not claimed.

When dispensing of a beverage is completed, the cover flap is positioned to overlay the dispensing mechanism for hygiene and for added discretion if the beverage contains alcohol.

The manner of using the item compartment 300 is identical to that for carryalls in present use. Namely, one gains access to the interior of a compartment for storing and carrying everyday items such as wallets, keys, cellular phones, tablets, etc. The difference is that this present invention allows the storing and carrying of these items that are moisture sensitive with a beverage that is stored and dispensed from an isolated, insulated beverage compartment 200.

### Additional Embodiments—FIG. 6

Additional embodiments are shown in FIG. 6 include: an opening 680 with fastening devices 682,684, in the lining 660 of the interior of the item compartment 300 for accessing a space between the lining and the base panel of the item compartment 672, allowing for storing of items out of immediate view when the item compartment 690 is accessed; a widen cover flap 562 allowing for a dispensing mechanism to be positioned on the exterior of the beverage compartment 691 for greater ease of dispensing beverages while still being unexposed when the cover flap 562 is in the closed position; an inclined wedge 520, 520a with the most shallow end near the opening 694 allowing for gravity assistance for moving a beverage to a dispensing mechanism; a completely removable cover flap 670 that may be connected with a chain or similar device spanning from the cover flap 670 to the beverage compartment 692 and removably adhered to the beverage compartment 692 with a fastening device, such as specialized fabric, magnetic strips, button, etc.

### Alternate Embodiment—FIG. 7

In an alternate embodiment, as depicted in FIG. 7, a carryall with substantial similarities to the First Embodiment as depicted in FIGS. 1 to 5, is in the form of a backpack 700 with a hard-shelled exterior with a finish comprised of plastic, metal, composite material, etc. or soft-shelled exterior comprised of natural or man-made fabrics, foam or rubber shell, etc.

The item compartment 730 exterior shell can differ in the material used from the beverage compartment 790 exterior shell.

This backpack version has at least one strap 770 or two straps 770, 771 possibly with a connecting strap 780 for carrying.

The beverage compartment 790 is fitted with a grommet 656 around the opening 620 on the gusset panel 740 of the beverage compartment 790.

The opening 720 is sufficient in it's length or diameter to accommodate a variety of sized beverage containers and pre-attached dispensing mechanisms, including but not limited to, beer growlers, box wine beverage bags, refillable beverage bags, and any other beverage container with a dispensing mechanism.

The cover flap 682 overlays the opening 720 until use. This cover flap is configured to be similar to the enlarged cover flap 662 depicted in FIG. 6.

The insulation 755, which can be optionally enhanced with thermally isolating foam panels or other material, comprises the double-shell structure of the beverage compartment 790 with its outer shell 784.

The lining 788, which can be made of hard or soft material, of the item compartment 730 comprises the double-shell structure of the item compartment 730 with its outer shell 786.

The zipper, or other fastening device, for accessing the item compartment 730, begins on either gusset 742,743, continues across the top panel 744 to the other gusset 742,743.

Two-way zippers may also be used.

The zipper, or other fastening device, for accessing the beverage compartment 790, begins on either side of the area 776 spanning the back panel of the item compartment 772 and the back panel of the beverage compartment 774, continues along the back panel 772,774, along the gusset panels 743,742, across the front panels 724,726 to the gusset panels 743.742 and continuing to the back panels 772,774. Two-way zippers may also be used.

Operating the backpack version of the compartmentalized carryall is identical to the operation of the First Embodiment.

### Advantages

From the description above, a number of advantages of some embodiments of my compartmentalized carryall become evident:
The capacity to bring your own beverage with you is cost-saving, convenient, and sanitary. A vendor selling wine, for instance, often charges many times what it costs to bring the same quality of wine with you in the carryall. Water is also a common beverage consumed outside the home by people and their pets. The convenience of being able to have a sizeable amount of water or other beverage is expressed as an important advantage of the present invention. It is very easy to conceive that this carryall could transport three liters or more plus it has the ability to store drinking vessels or pet bowls in the upper compartment.
The carryall is designed to discreetly allow dispensing of a beverage directly from the opening. When dispensing of the beverage is accomplished, the cover flap is positioned over the opening so that the carryall gives the appearance of an ordinary carryall.
Most people carry at least two moisture-sensitive items, namely keys and cellular phones, with them every day. It is important to keep these electronic items safe from liquid or moisture exposure. The present invention provides a separate compartment for storing these items so that they should not be exposed to liquid or moisture.
Carrying your beverage and drinking vessels with you is an advantage in that your drink is less exposed and vulnerable to tampering. The cleanliness of glassware is known as it has been brought in the carryall.
While most wine consumers would enjoy the cost savings of box wine over expensive bottled wine, few would bring box wine to a dinner party. With the elegant carryall, this stigma is alleviated and the remaining wine could be brought home rather than left with the hosts as common courtesy dictates.
Beer growlers are growing in popularity as they allow the consumption of tap beer outside a bar or brewery. Beer growlers can be affixed with dispensing mechanisms and placed in the carryall's insulated beverage compartment. The carryall allows for the beer to be directly poured from the carryall, again with discretion, plus the insulated compartment maintains a more optimal temperature.
Insulation surrounding the beverage compartment helps to maintain an optimal temperature, whether hot or cold, for any beverage container. The beverage compartment can accommodate a variety of beverage bag sizes and beverage bottles.
The insulated area can be used to transport more than beverages in containers that are fitted with a dispensing mechanism. It can contain snacks and other foods. It can also store canned or bottled beverages that should be separated from everyday items such as keys and cellular phones.
The sizing of the carryall and placement of the opening can accommodate a wine bottle with an affixed pourer/stopper. There are several pourer/stoppers on the market that can meet this need.
An alternative embodiment of the present invention allows the storing and dispensing from two beverage containers from two compartments. For instance, one container can hold water or fruit juice and the other container can contain a different beverage.
Portion control is also an advantage with the carryall as you serve yourself directly from the carryall.

### CONCLUSION, RAMIFICATIONS, AND SCOPE

Accordingly, the reader will see that the compartmentalized carryall of the various embodiments can be used to safely store and transport everyday electronic items along with beverages that are discreetly dispensed directly from an insulated compartment of the carryall. In addition, the opening is concealed by a cover flap allowing for discretion and a more hygienic environment for the dispensing mechanism than if the dispensing mechanism is left continually exposed.

Furthermore, the compartmentalized carryall has the additional advantages in that:
it permits a beverage to be more easily dispensed with the opening on the gusset or short end of the carryall than if the opening was on the long panel side. It is much easier to tip the beverage container in this simple forward motion than to awkwardly position the beverage container to the side and pivot to the side the opening is located. With the opening on the gusset side, as in the present invention, a beverage can more easily be dispensed even with the carryall hanging from the shoulder. Also, a wine bottle fitted with a pourer/stopper could not be used if the opening is located on the long side panel. A wine bottle with a pourer/stopper can be utilized with the present invention, however.
it permits safe portability of electronic items. Most electronic everyday items, including key fobs, cellular phones, and electronic tablets are expensive. Protecting these items from unnecessary damage is important. Often, these items can be harmed by simply not screwing on a bottle cap sufficiently and placing it near an electronic device. Placing this unsecured bottle into the same area as electronic items risks spillage and thus damage to the electronic items. Having a space within a carryall specifically for beverages or liquids that is separated from electronic items can protect these items.
it permits a choice of preferred beverages, whether contained in a wine bottle or other container, to be readily available and directly dispensible with the present invention.
It permits the beverage compartment to be used at any time. The present invention, having two separate compartments, allows for both compartments to be used for transporting and storage at any time. The cover flap over the opening provides an enclosed spaced for transporting items. Other prior art have an opening that is always exposed and any items stored in the compartment can be vulnerable to loss through the unsecured opening.
It permits safe portability of non-electronic and electronic items. The insulated beverage compartment of the present invention is constructed to contain both beverage containers and other items, i.e. sandwiches, fruit cheeses, without worrying that these items will be compressed. Other prior art has the carryall being rolled up to form the handle. This would compress any items stored within the carryall.
It permits items that do not need to be temperature controlled to be stored and transported in a separate compartment. Other prior art has the entire space designated for a beverage bag in an insulated area. This requires that any other items be stored in this space as well. Retrieval of these items opens the insulated area releasing cooled or warmed air and diminishing the insulating capabilities of the prior art.

I claim:

1. A carryall comprising a plurality of panels creating at least two distinct compartments with specific uses, with at least one strap attached to the carryall such that the carryall can be suspended by at least one strap for ease of portability, defining a beverage compartment in the carryall, said beverage compartment being configured to accept a beverage container, an opening on at least one gusset panel of said beverage compartment allowing for ease of external accessibility and dispensing of said beverage container's contents, and an attached protective cover flap overlaying said opening, and a separated item compartment for storing and transporting everyday items including items with electronic components that should be protected from moisture and liquid exposure, thus said beverage compartment and said item compartment constitute a means to transport, store, and discreetly dispense insulated liquid beverages with said everyday electronic items in separate compartments of a carryall.

2. A carryall according to claim 1 wherein said beverage compartment is lined with insulating material along four exterior panels, bottom panel, and top panel.

3. A carryall according to claim 1 wherein said beverage compartment is opened and closed with a substantially horizontal zipper or other fastening device substantially surrounding said beverage compartment, allowing access for placement of said beverage container by temporarily displacing said item compartment.

4. A carryall according to claim 1 wherein said cover flap fully overlays said opening, said cover flap attached so as to be fully detachable or partially detachable from carryall for protection of said beverage container dispensing mechanism from the environment, concealment of said dispensing mechanism, and containment of said beverage bag and other matter stored and transported within said beverage compartment.

5. A carryall further comprising a said item compartment with four substantially vertical panels, top, and a substantially horizontal bottom panel separating said item compartment from said beverage compartment described in claims 1, with said zipper or other fastening device closure, interior of said item compartment lined in material, with access to said item compartment from said top of carryall.

6. A carryall comprising a plurality of exterior panels defining a said beverage compartment and a said item compartment, both said beverage compartment and said item compartment can be individually accessed and are separated by a substantially horizontal panel in the interior of carryall, said beverage compartment and said item compartment are partially attached along one long exterior panel by a zipper as according to claim 3, said beverage compartment being configured to accommodate various types of beverage containers including but not limited to wine bottles, thermos-type containers, growlers, beverage bags with attached spigots as found in box wine, and refillable containers, with access to said beverage container dispensing mechanism through a said opening from said beverage compartment to carryall exterior, said opening allowing for penetration of said dispensing mechanism to carryall exterior to enable dispensing of beverage, with said cover flap overlaying said opening until removed to allow for dispensing of beverage from said beverage container.
